(19) United States
(12) Patent Application Publication
(10) Pub. No.: US 2009/0095128 A1
(43) Pub. Date: Apr. 16, 2009

(54) UNIFORM AEROSOL DELIVERY FOR FLOW-BASED PYROLYSIS FOR INORGANIC MATERIAL SYNTHESIS

(76) Inventors: Bernard M. Frey, Livermore, CA (US); Peter R. Buerki, Oceanside, CA (US); Robert B. Lynch, Livermore, CA (US); Janet L. Wang, San Jose, CA (US); Gabriel Tran, San Jose, CA (US); Craig R. Horne, Sunnyvale, CA (US); Dean M. Holunga, Albuquerque, NM (US); Igor Altman, Fremont, CA (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 12/233,325

(22) Filed: Sep. 18, 2008

Related U.S. Application Data
(60) Provisional application No. 60/994,858, filed on Sep. 21, 2007.

(51) Int. Cl. B22F 9/02; B01J 19/08

(52) U.S. Cl. 75/338; 422/186

(57) ABSTRACT

Light-driven flow reactors are configured with an aerosol delivery apparatus that is designed to improve the reactive process with respect to forming uniform product compositions at higher rates. In particular, the reactant delivery system can deliver an aerosol having an average droplet size of no more than about 50 microns, and in some embodiments 20 microns, and with less than 1 droplet in 10,000 having a diameter greater than 5 times the average droplet size. In some embodiments, the edge of the aerosol generator can be placed within about 6 centimeters of the edge of the light beam passing through the reaction chamber. The average aerosol velocity can be no more than about 5 meters per second. In some embodiments, the aerosol generator can comprise a non-circular opening and a gas permeable structure that is used to generate a mist that is delivered from the apparatus as an aerosol.

### CROSS REFERENCE TO RELATED APPLICATION

This application claims priority to U.S. provisional patent application 60/994,858 filed on Sep. 21, 2007 to Buerki et al., entitled “Improved Aerosol Delivery for Light Driven Particle Synthesis,” incorporated herein by reference.

### FIELD OF THE INVENTION

The invention relates to apparatuses and processes for the delivery of aerosol precursors for light driven pyrolysis directed to particles synthesis, such as submicron particle synthesis and/or to a reactive deposition process driven by a light beam with direct coating of a substrate in the reaction chamber.

### BACKGROUND OF THE INVENTION

Advances in a variety of fields have created a demand for many types of new materials. In particular, a variety of chemical powders can be used in many different processing contexts. Specifically, there is considerable interest in the application of ultrafine or nanoscale powders that are particularly advantageous for a variety of applications involving small structures or high surface area materials. This demand for ultrafine chemical powders has resulted in the development of sophisticated techniques, such as laser pyrolysis, for the production of these powders.

In general, some particle production techniques involve flow reactions that result in the formation of product particles in a flow stream that are collected as a powder. The quantities of particles are harvested from the flow stream in which they are produced using an appropriate collector. To commercially exploit these particle production processes on a practical scale, the processes should be capable of efficiently producing commercial scale quantities of particles in a reasonable period of time. Coating techniques have been developed for the direct coating of reaction products from a light driven reaction that can take advantage of the uniformity of the product composition and the versatility in selecting the product composition.

### SUMMARY OF THE INVENTION

In a first aspect, the invention pertains to a apparatus comprising a reaction chamber and a reactant delivery system, in which the reaction chamber comprises a optical elements defining a light beam path through the reaction chamber. The reactant delivery system can comprise an aerosol generator configured to deliver an aerosol into the reaction chamber, in which the aerosol droplets in the reaction chamber have an average droplet diameter of no more than about 50 microns and less than 1 droplet in 10,000 having a diameter greater than 5 times the average droplet size.

In further aspects, the invention pertains to an apparatus comprising a reaction chamber and a reactant delivery system, in which the reaction chamber comprises optical elements defining a light beam path through the reaction chamber. In some embodiments, the reactant delivery system comprises an aerosol delivery apparatus configured to deliver an aerosol into the light beam path with the edge of the aerosol generator positioned no more than about 6 centimeters of the closest edge of the light beam path with an average aerosol velocity of no more than about 5 meters per second and the average aerosol droplet size is not more than about 50 microns.

In other aspects, the invention pertains to an aerosol generation apparatus comprising a non-cylindrical vessel, a gas permeable structure, and a liquid delivery unit. In general, the vessel has an inner volume with a non-circular opening, a gas permeable structure with a surface exposed to the inner volume of the vessel and an opposing surface contacting an enclosed volume operably connected to a gas source. The liquid delivery unit generally is configured to deliver a liquid from a liquid supply to the exposed surface of the gas permeable structure.

In additional aspects, the invention pertains to a method for generating particles comprising flowing an aerosol through a light beam in which the aerosol exits the aerosol generator within about 6 centimeter of the closest edge of the light beam at a velocity of no more than about 5 meters per second to produce particles having an average particle diameter of no more than about 500 nm and a essentially no particles having a diameter greater than about 5 times the average particle diameter.

### BRIEF DESCRIPTION OF THE DRAWINGS

FIG. 1 is a schematic sectional view of a general light driven reaction apparatus that is suitable for particle production or optionally for coating deposition.

FIG. 2 a schematic side view of a light-driven pyrolysis reaction chamber with an elongated reactant inlet for a high throughput based on a sheet of flow.

FIG. 3 is a perspective view of a further embodiment of an elongated reaction chamber for performing laser pyrolysis.

FIG. 4 is a cut away, side view of the reaction chamber of FIG. 3.

FIG. 5 is another embodiment of a laser pyrolysis apparatus with an elongated reactant nozzle with a particle transport section having four modification stations.

FIG. 6 is a perspective view of an embodiment of a reaction chamber for performing light reactive dense deposition.

FIG. 7 is an expanded view of the reaction chamber of the light reactive deposition chamber of FIG. 6.

FIG. 8 is an expanded view of the substrate support of the reaction chamber of FIG. 6.

FIG. 9 is a schematic diagram of a reactant delivery system with an aerosol generator interfaced with a gas delivery subsystem, a vapor delivery subsystem and a mixing subsystem to deliver a gas/vapor mixture.

FIG. 10 is a perspective view of an aerosol generator comprising a porous roller configured for mist generation for the delivery of the aerosol, in which the walls of the aerosol generator are shown as transparent such that inner structure can be viewed.

FIG. 11 is a sectional side view of the aerosol generator of FIG. 10, with the section taken along line 11-11 of FIG. 10.

### DETAILED DESCRIPTION OF THE INVENTION

With aerosol reactant delivery for light driven pyrolysis, improved control of aerosol properties provides for improved product particle properties and/or product coating properties at high production rates. In general, appropriate parameters relating to improved aerosol properties include, for example, smaller and more uniform aerosol droplets and/or lower velocity aerosol droplets. In addition, the placement of the aerosol generator can contribute significantly to improvements with respect to product properties. Better control of aerosol generation can also result in process efficiencies at higher production rates without sacrificing product quality. For example, in some embodiments, the improved systems can reduce the consumed amount of carrier gas in the process, which can result in a significant reduction in operating cost while reducing waste. At the same time product powder or coating quality can improve at higher production rates through better control of the aerosol properties. Thus, the improvements described herein provide significant commercial benefits relating to the production of uniform nanoparticles or inorganic coatings at commercial production rates.

As described herein, the aerosol delivery apparatuses can be used effectively in light driven pyrolysis reaction systems where the aerosol comprises droplets, which may be entrained in or otherwise delivered with a carrier gas flow. In light based pyrolysis, the reaction to produce the product particles and/or coating composition is driven by energy from an intense light beam, such as a laser beam. In general, light driven pyrolysis can be performed with vapor reactants, gaseous reactants, aerosol reactants or a combination thereof. In addition to the synthesis of submicron particles, light driven reactions have been used to perform direct coating of substrates in which the substrate is scanned through the product stream to coat a substrate within a reaction chamber. The ability to deliver aerosol reactants significantly increases the flexibility for the selection of desirable reaction precursors as well as correspondingly obtaining desired product compositions.

Desirable reactant throughput and corresponding product production rates can be accomplished through the flow of a larger quantity of reactant composition in the flow through the light beam. It has been found that a way to accomplish this objective without degrading product quality is to extend the reactant flow laterally along the light beam. A high production rate laser pyrolysis apparatus is described in U.S. Pat. No. 5,958,348 to Bi et al., entitled “Efficient Production of Particles by Chemical Reaction,” incorporated herein by reference. With respect to aerosol precursors, this can be accomplished through the shaping of the aerosol flow and/or through the use of a plurality of aerosol generators, which can be positioned in a linear array.

In light driven pyrolysis, the reactant stream is pyrolyzed by an intense light beam, such as a laser beam. While a laser beam is a convenient energy source, other intense light sources can be used to drive the reaction process. The light beam provides an energy source that stabilizes or ignites reactions that otherwise may be kinetically or thermodynamically unfavorable, enabling the formation of materials and/or material phases that are difficult to achieve otherwise. As the reactant stream leaves the light beam, the inorganic product particles are rapidly quenched, although product flow can be intercepted to directly form a coating onto a substrate.

Light driven pyrolysis for submicron particle production has been termed laser pyrolysis. A laser pyrolysis apparatus generally comprises a reaction chamber connected to a reactant delivery system and a collection system that harvests the product particles as a powder. The light beam path traverses the reaction chamber and is associated with appropriate optics to direct the light beam. The reaction chamber generally is isolated from the ambient environment, and the pressure within the reaction chamber can be maintained at an appropriate value using a pump, blower or other appropriate flow device. The pressure within the reaction chamber influences the properties of the product particles, and suitable pressures generally range from about 80 Torr to about 700 Torr. A person of ordinary skill in the art will recognize that additional ranges of pressure within this explicit range are contemplated and are within the present disclosure. As noted below in more detail, the reactant delivery systems can also be adapted for coating formation based on light driven product deposition from a flow using a process termed light reactive deposition.

Generally, relevant reaction systems, appropriately configured, can operate with gas and/or vapor phase reactants. If the reactants are limited to gas and/or vapor (gas/vapor) phase reactants, the types of materials that can be produced economically by laser pyrolysis are limited significantly because the range of reactants is correspondingly limited. For example, many solid reactants cannot be used since their vapor pressures are so low at reasonable temperatures that little, if any, reactant can be introduced into a vapor phase. Also, some liquid reactants may be inconvenient or impractical for vapor delivery due to, for example, toxicity, cost, and/or low vapor pressures. Furthermore, aerosol delivery can avoid decomposition or premature reaction of a reactant that is unstable or highly reactive when delivered as a vapor.

The use of an aerosol delivery apparatus provides for the use of a wider range of reactants. For example, solid or liquid reactants can be dissolved into a solvent and delivered as an aerosol. In addition, liquid reactants can be directly delivered as an aerosol or as a liquid solution even if they have insufficient vapor pressure for the delivery of desired quantities of reactant in the gas phase. Thus, the availability of additional reactants for delivery as aerosols can provide approaches for the production of certain products that otherwise may not be practical.

In a laser pyrolysis apparatus, a light absorbing material, possibly one or more of the reactants themselves or a solvent, rapidly transmit heat to the reactants. The reactants reach very high temperatures. Solvent, if any, generally is rapidly vaporized. The uniformity of the aerosol assists with the production of a more uniform product, for example, nanoparticles with a narrow size distribution.

In the light driven reactions, the reactant delivery system interfaces with the reaction chamber at one or more inlets from which a flow is initiated through the reaction chamber. The reactant flow passes through a light beam and subsequently exits the reaction chamber. The reactants react in the flow at a reaction zone to form product compositions downstream from a reaction zone. In laser pyrolysis, product particles form in the flow, which are collected and harvested as a powder. In light reactive deposition, the product compositions are directly deposited onto a moving substrate to form a coating. Light reactive deposition to form a porous particle coating is described further in U.S. published patent application 2003/0228415A to Bi et al., entitled “Coating Formation by Reactive Deposition,” incorporated herein by reference. Light reactive deposition to directly form denser coatings are described further in U.S. published patent application 2006/0134347A to Chiruvolu et al., entitled “Light Reactive Dense Deposition,” incorporated herein by reference. Light reactive deposition is capable of forming very highly uniform coatings as described further in published U.S. patent application 2005/0019504A to Bi et al., entitled “High Rate Deposition for the Formation of High Quality Optical Coatings,” incorporated herein by reference.

The adaptation of aerosol delivery for various laser pyrolysis reactor systems is described in U.S. Pat. No. 6,193,936 to Gardner et al., entitled “Reactant Delivery Apparatuses,” incorporated herein by reference. The present application describes further significant improvements on this technology to provide for high quality product compositions from the light-driven reaction of an aerosol at higher production rates. The '936 patent teaches, for example, the use of an array of aerosol generators that can be positioned to generate the aerosol essentially within the reaction chamber along an extended length of the laser beam or alternatively using an aerosol generator within a nozzle configured with an opening along an extended length of the light beam with an entraining gas to conform the aerosol to the shape of the opening into the reaction chamber. However, the '936 patent failed to recognize the parameters of the aerosol flow, described herein, that provide for commercially desirable production capabilities while maintaining high quality product synthesis and providing more efficient use of resources, such as inert entraining gas. While the '936 patent represented a significant advance in the laser pyrolysis field, the present work extends these advances in important directions. In particular, the aerosol delivery apparatuses described herein provide significant improvements with respect to delivering a commercially significant amount of reactant flow through the light beam with parameters that provide for high quality particle production.

The reaction apparatuses described herein incorporate reactant delivery systems with improved selection and placement of the aerosol generators to provide high throughput aerosol delivery while maintaining desired product quality, in particular a high degree of product uniformity. To achieve the improved reaction performance, the aerosol generator can be positioned closer to the light beam. This placement of the aerosol generator provides for a reduced coalescence of the aerosol droplets as well as a reduced alteration of the aerosol flow between the generation of the aerosol and the reaction zone. This approach may reduce backflow of the aerosol liquid as well as improve aerosol qualities reaching the reaction zone. In particular, if the aerosol generator is placed further from the reaction zone, constraints to limit spreading of the aerosol so that the aerosol substantially completely flows through the light beam can result in increased coalescence of the aerosol droplets that results in larger particles, decreased uniformity of the aerosol and condensation of the droplets that then can rain out of the flow.

Further improvement in the reaction process can result from the control of the aerosol properties. In some embodiments, the aerosol generators are selected to provide more uniform aerosol droplets and/or smaller aerosol droplets. The smaller and more uniform aerosol droplets can result in more uniform aerosol flow through the light beam such that the product composition is correspondingly more uniform downstream from the reaction zone. If the aerosol generator is placed closer to the light beam and/or if the aerosol is not significantly constrained between the generator and the light beam, the properties of the aerosol as generated correspond reasonably closely with the properties of the aerosol entering the light beam.

In general, it is desirable for the aerosol droplets to be relatively small, such as with a volume average droplet size of no more than about 50 microns and in some embodiments no more than about 10 microns. The aerosol droplet sizes can be measured using light scattering, as described further below. In addition, if the aerosol droplets are more uniform in size distribution, there are fewer, if any, outlying droplets with respect to size. While not wanting to be limited by theory, it is thought that for the reactions to take place, generally the aerosol droplets are substantially vaporized to provide for inorganic particle formation. Thus, a larger number of larger droplets can be detrimental to the resulting product uniformity in the flow. The uniformity of the product flow corresponds with the particle uniformity for particle collection and coating uniformity with respect to direct coating deposition.

Another significant parameter of the aerosol with respect to subsequent particle synthesis is the aerosol velocity. The velocity of the reactants through the light beam influences the properties of the reaction product, particles and/or reactant composition. If the aerosol is generated within a conduit of the reactant delivery system and entrained in a gas flow, the velocity of the aerosol can be adjusted by the velocity of the entraining gas as well damping of the aerosol velocity due to flow constraints. Thus, if the aerosol generator produces the droplets at a higher velocity than desired in the reaction zone of the reactor, the aerosol generator can be moved further from the reaction zone so that the velocity of the aerosol flow can moderate based on entraining gas flow.

Configurations based on moving the aerosol generator away from the reaction zone results in spread of the aerosol flow that can consume an undesirably large amount of entraining gas to control the flow. Also, in some embodiments, the aerosol generator can be surrounded in a nozzle with the walls of the nozzle further constraining the aerosol flow, but interactions with the walls of the nozzle can result in increased drip back, droplet growth and corresponding loss of reactive flow into the reaction zone. Within the nozzle the velocity of the aerosol flow can be moderated to match the flow of the entraining gas, although this involves the use of a large volume of entraining gas.

However, if the aerosol is generated at a suitable velocity, the aerosol generator can be placed close to the light beam, and the aerosol can be delivered with less constraint of the flow. Based on an analysis of these conditions, significant improvement in the performance results from the use of an aerosol generator that directly produces a lower velocity aerosol mist. Specifically, in some embodiments, the average aerosol velocity can be no more than about 5 meters per second in the vicinity of the aerosol generator edge. For these embodiments, the aerosol generator can be placed with the edge of the aerosol generator near the light beam. This provides for very uniform and reproducible conditions as well as reduced agglomeration of droplets in flight and selection of the reactant flow velocity through the light beam. This placement of the aerosol generator can also result in a significant reduction in entraining gas consumption.

For laser pyrolysis or light reactive deposition, the inorganic product composition generally comprises a metal or metalloid species. The word “element” is used herein in its conventional way as referring to a member of the periodic table in which the element has the appropriate oxidation state if the element is in a composition and in which the element is in its elemental form, M⁰, only when stated to be in an elemental form. Therefore, a metal element generally is only in a metallic state in its elemental form or a corresponding alloy of the metal's elemental form. In other words, a metal oxide or other metal composition, other than metal alloys, generally is not metallic. To supply the desired elements for the product particles, the reactant flow is selected to comprise the appropriate elements for the desired product within the flow.

In some embodiments, the approaches described herein provide for the production of composite product inorganic compositions comprising multiple metals species. The product compositions can comprise stoichiometric multiple metal/metalloid compositions, and alternatively or additionally, one or more metal or metalloid elements can be dopants within a host lattice or within a solid composition dissolved within a dominant amorphous solid composition. Inorganic compositions with a plurality of metal species can be formed with a light driven reaction in a direct way by mixing compositions with different metals within the aerosol delivery apparatus. For example, the aerosol delivery apparatus can be used to deliver a solution in which two or more different metal/metalloid compounds are dissolved into the solution, in which two neat liquid metal/metalloid compounds are mixed or combinations thereof. The relative amounts of metal and/or metalloid elements in the resulting particles can be adjusted by varying the relative amounts of metal and/or metalloid elements in the aerosol, although the reaction may alter the relative amounts of elements in the product compositions depending on the particular reactions involved.

Alternatively, a metal compound or compounds in the aerosol can be mixed in a variety of ways described below with one or more vapor metal reactants. Similarly, two different aerosols can be combined where each aerosol contains one or more metal compounds. Thus, the aerosol delivery approaches described herein provide very versatile approaches to production of nanoparticles of composite (i.e., multiple) metal/metalloid compounds. The ability to control and improve the aerosol characteristics provides for the production of product compositions at higher rates while maintaining high quality product compositions with respect to uniformity.

### Light Driven Reactive Flow Processes

Based on the description herein, light driven reactions can be adapted for particle synthesis and/or coating deposition within the reactor. Laser pyrolysis has become the standard terminology for flowing chemical reactions for particle synthesis driven by intense radiation, e.g., light, with rapid quenching of product inorganic particles after leaving a reaction region formed by the radiation intersecting with the reactant flow. The name, however, is a misnomer in the sense that radiation from non-laser sources, such as a strong, incoherent light or other electromagnetic beam, can replace the laser. Also, the reaction is not a pyrolysis in the sense of a thermal pyrolysis. The laser pyrolysis reaction is not solely thermally driven by the exothermic combustion of the reactants. In fact, in stark contrast with pyrolytic flames, in some embodiments laser pyrolysis reactions can be conducted under conditions where no visible light emissions are observed from the reaction and/or where the flow does not comprise combustible compositions. Light reactive deposition involves the scanning of a coating substrate through a product flow downstream from a light reaction zone within a reaction chamber supporting a light driven reaction. While the interface of the substrate with the flow significantly alters the flow within reaction chamber, the flow can be appropriately controlled to result in a highly uniform coating.

The reaction conditions for the light driven reaction can be controlled relatively precisely in order to produce inorganic compositions with desired properties. For example, the reaction chamber pressure, flow rates, composition and concentration of reactants, radiation intensity, radiation energy/wavelength, type and concentration of inert diluent gas or gases in the reaction stream, temperature of the reactant flow can affect the composition and other properties of the product compositions, e.g., particles, such as by altering the time of flight of the reactants/products in the reaction zone and the quench rate. Thus, in a particular embodiment, one or more of the specific reaction conditions can be controlled. The appropriate reaction conditions to produce a certain type of particles or coating materials generally depend on the design of the particular apparatus. Some general observations on the relationship between reaction conditions and product particles can be made.

Increasing the light power results in increased reaction temperatures in the reaction region as well as a faster quenching rate. A rapid quenching rate tends to favor production of higher energy phases, which may not be obtained with processes near thermal equilibrium. Similarly, increasing the chamber pressure also tends to favor the production of higher energy phases. Also, in appropriate embodiments, increasing the concentration of the reactant serving as the oxygen source, nitrogen source, sulfur source or other secondary reactant source in the reactant stream favors the production of particles with increased amounts respectively of oxygen, nitrogen, sulfur or other secondary reactant.

Reactant velocity of the reactant stream is inversely related to particle size so that increasing the reactant velocity tends to result in smaller particle sizes. A significant factor in determining particle size is the concentration of product composition condensing into product particles. Reducing the concentration of condensing product compositions generally reduces the particle size. The concentration of condensing product can be controlled by dilution with non-condensing, e.g., inert, compositions or by changing the pressure with a fixed ratio of condensing product to non-condensing compositions, with a reduction in pressure generally leading to reduced concentration and a corresponding reduction in particle size and vice versa, or by combinations thereof, or by any other suitable means.

Light power during laser pyrolysis also influences inorganic particle sizes with increased light power favoring smaller particle formation, especially for higher melting temperature materials. Also, the growth dynamics of particles have a significant influence on the size of the resulting particles. In other words, different forms of a product composition have a tendency to form different size particles from other phases under relatively similar conditions. Similarly, under conditions at which populations of particles with different compositions are formed, each population of particles generally has its own characteristic narrow distribution of particle sizes.

Furthermore, the velocity of the reactant stream can influence the density of a coating deposited by light reactive deposition. Another significant factor in determining the coating parameters is the concentration of product composition within the product stream. Reducing the total concentration as well as the relative concentration of condensing product composition within the product flow results in a slower particle growth rate and smaller particles. The relative concentration of condensing product can be controlled by dilution with non-condensing, e.g., inert, compositions or by changing the pressure with a fixed ratio of condensing product to non-condensing compositions, with a reduction in pressure generally leading to reduced total concentration. Also, different product compositions have a tendency to coalesce at different rates within the product flow, which can correspondingly influence the coating density. In summary, the coating parameters can be selected to adjust the coating density.

Inorganic product materials of interest include, for example, amorphous materials, crystalline materials, combinations thereof and mixtures thereof. Amorphous inorganic materials possess short-range order that can be very similar to that found in crystalline materials. In crystalline materials, the short-range order comprises the building blocks of the long-range order that distinguishes crystalline and amorphous materials. In other words, translational symmetry of the short-range order building blocks found in amorphous materials creates long-range order that defines a crystalline lattice. In general, the crystalline form is a lower energy state than the analogous amorphous form. This provides a driving force towards formation of long-range order. In other words, given sufficient atomic mobility and time, long-range order can form.

In light driven flow reactions, a wide range of inorganic materials can be formed in the reactive process. Based on kinetic principles, higher quench rates favor amorphous material formation while slower quench rates favor crystalline material formation as there is time for long-range order to develop. Faster quenches can be accomplished with a faster reactant stream velocity through the reaction zone. In addition, some precursors may favor the production of amorphous materials while other precursors favor the production of crystalline materials of similar or equivalent stoichiometry. The formation of amorphous metal oxides particles and crystalline metal oxide particles with laser pyrolysis is described further in U.S. Pat. No. 6,106,798 to Kambe et al., entitled “Vanadium Oxide Nanoparticles,” incorporated herein by reference.

To form desired inorganic product materials in the light-driven reaction process, one or more precursors generally supply the one or more metal/metalloid elements that are within the desired composition. The reactant stream generally would comprise the desired metal element(s) and, additionally or alternatively, metalloid element(s) to form the desired composition and, optionally, dopant(s)/additive(s) in appropriate proportions to produce product inorganic materials with a desired composition. Furthermore, additional appropriate precursor(s)/reactant(s) can supply other element(s) for incorporation into the product inorganic particles. The composition of the reactant stream can be adjusted along with the reaction condition(s) to generate desired product materials with respect to composition and structure, e.g., crystallinity. Based on the particular reactants and reaction conditions, the product compositions may not have the same proportions of metal/metalloid elements as the reactant stream since the elements may have different efficiencies of incorporation into the product compositions, i.e., yields with respect to unreacted materials. However, the amount of incorporation of each element is a function of the amount of that element in the reactant flow, and the efficiency of incorporation can be empirically evaluated based on the teachings herein to obtain desired compositions. The designs of the reactant delivery systems for radiation driven reactions described herein are designed for high yields with high reactant flows.

For the performance of light driven flow synthesis of inorganic compositions, the energy absorbed from the light beam increases the temperature at a tremendous rate, many times the rate that heat generally would be produced by exothermic reactions under controlled condition(s). While the process generally involves nonequilibrium conditions, the temperature can be described approximately based on the energy in the absorbing region. The light driven process is qualitatively different from the process in a combustion reactor where an energy source initiates a reaction, but the reaction is driven by energy given off by an exothermic reaction. Thus, while the light driven process for particle collection is referred to as laser pyrolysis, it is not a traditional pyrolysis since the reaction is not driven by energy given off by the reaction but by energy absorbed from a radiation beam. If necessary, the flow can be modified such that the reaction zone remains confined.

With suitable high throughput reactor designs, high inorganic product material production rates can be achieved. The product production rate based on reactant delivery configurations described herein can yield particle production rates in the range(s) of at least about 0.1 g/h, in some embodiments at least about 10 g/h, in some embodiments at least about 50 g/h, in other embodiments in the range(s) of at least about 100 g/h, in further embodiments in the range(s) of at least about 250 g/h, in additional embodiments in the range(s) of at least about 1 kilogram per hour (kg/h) and in general up in the range(s) up to at least about 10 kg/h. A person of ordinary skill in the art will recognize that additional values of particle production rate within these specific values are contemplated and are within the present disclosure.

In general, these high production rates can be achieved while obtaining relatively high reaction yields, as evaluated by the portion of metal/metalloid nuclei in the flow that are incorporated into the product inorganic materials. In general, the yield can be in the range(s) of at least about 30 percent based on the limiting reactant, in other embodiments in the range(s) of at least about 50 percent, in further embodiments in the range(s) of at least about 65 percent, in other embodiments in the range(s) of at least about 80 percent and in additional embodiments in the range(s) of at least about 95 percent based on the metal/metalloid nuclei in the reactant flow. A person of ordinary skill in the art will recognize that additional values of yield within these specific values are contemplated and are within the present disclosure.

Similar rates can result with respect to coating deposition, although for coating deposition, the deposition efficiency also influences the coating rates. At moderate rates of relative substrate motion, coating efficiencies in the range(s) of not less than about 15 to about 20 percent can be achieved, i.e. about 15 to about 20 percent of the produced product composition is deposited on the substrate surface. Routine optimization can increase this deposition efficiency further. At slower relative motion of the substrate through the product stream, deposition efficiencies in the range(s) of at least about 40 percent and in additional embodiments in the range(s) of as high as 80 percent or more can be achieved. In general, with the achievable product production rates and deposition efficiencies, deposition rates can be obtained in the range(s) of at least about 5 g/hr, in other embodiments in the range(s) of at least about 25 g/hr, in further embodiments in the range(s) of at least from about 100 g/hr to about 5 kg/hr and in still other embodiment in the range(s) from about 250 g/hr to about 2.5 kg/hr. A person of ordinary skill in the art will recognize that coating efficiencies and deposition rates between these explicit rates are contemplated and are within the present disclosure. Exemplary rates of product deposition (in units of grams deposited per hour) include in the range(s) of not less than about 0.1, 0.5, 1, 5, 10, 25, 50, 100, 250, 500, 1000, 2500, or 5000.

### Reaction Apparatus

The light reactive flow apparatuses of particular interest comprise a reaction chamber with a light beam path, an exhaust from the reaction chamber, an optional coating system and a reactant delivery system for the delivery of an aerosol with improved characteristics described herein. In particular, in some embodiments, the apparatus can be designed to position an aerosol generator close to the light beam, and the aerosol generator can be designed to form the aerosol at a suitable velocity for direct introduction into the reaction zone and/or with smaller and/or more uniform droplets. The apparatus can be designed for a significant flow of precursor aerosol through the light beam to generate desired amounts of product compositions. The product compositions can be collected as submicron particles in an appropriate collector, and/or the product compositions can be directed at a substrate to be coated that is scanned through the product flow.

A reactant delivery system initiates a flow comprising precursors for the formation of the inorganic product composition, e.g., submicron particles or coating material. As described above, flow relates to a net movement of mass from one point to another. Generally, the flow path within the reaction apparatus extends from one or more inorganic particle reactant precursor inlets to a collector system. If the reaction system comprises a coating system, the apparatus generally still comprises a collector to remove product materials from the flow gases that did not coat onto the substrate. Along the flow, the inorganic product compositions are synthesized at a light reaction zone overlapping with the region of intersection of the reactant flow and the light beam. Generally, a negative relative-pressure device is used to maintain the flow through the apparatus along the flow path. Suitable negative relative-pressure devices include, for example, a pump, a blower, an aspirator/venturi, compressor, ejector or the like.

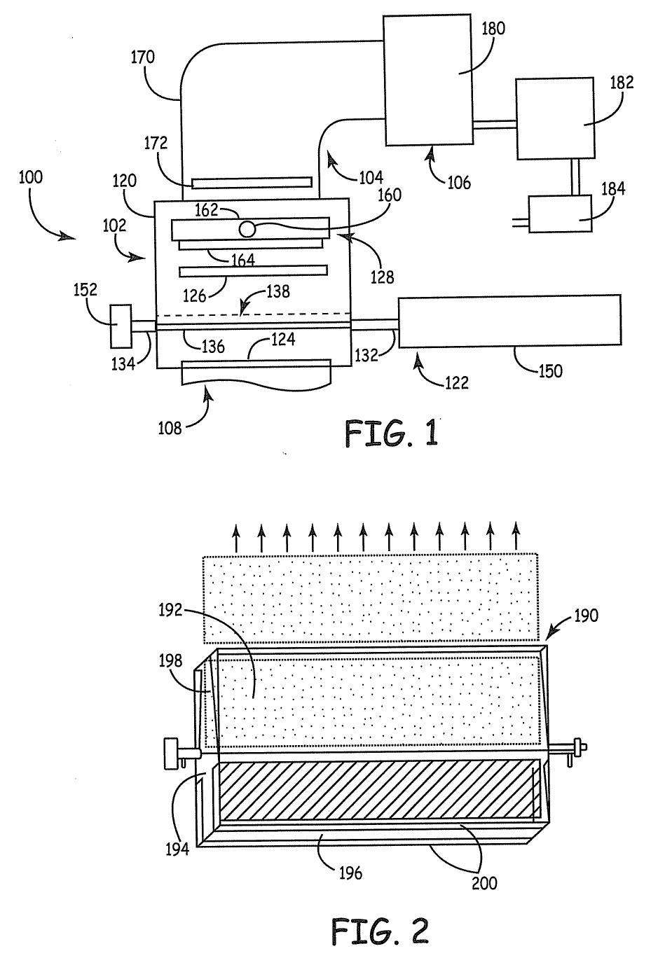

Referring to FIG. 1, light driven flow pyrolysis apparatus 100 comprises a reaction chamber 102, particle transport section 104, collection system 106 and a reactant delivery system 108. Reaction chamber 102 comprises a main chamber 120, an intense light delivery apparatus 122, a reactant inlet 124, an optional particle modifying section 126 having one and/or more modification elements and an optional substrate coating system 128. Main chamber 120 confines the reaction for the formation of the inorganic product compositions. Main chamber 120 comprises a light inlet conduit 132, a light outlet conduit 134 that forms a light beam path 136 aligned with light beam conduit 132, and a reaction zone 138 in the vicinity of and generally overlapping with the intersection of a light beam path 136 and the flow path of reactants from reactant inlet 124. Main chamber 120 interfaces with reactant delivery system at reactant inlet 124, although the interface can comprise a plurality of inlets, as described further below. The reactant inlet is aligned such that all or most of the reactant flow passes through a light beam along the light beam path. While the apparatus in FIG. 1 is shown with the flow going upward, the orientation can be reversed with the flow going downward.

Referring to FIG. 1, intense light delivery apparatus 122 generally can comprise an intense light source 150 and suitable optics, which are connected to light inlet conduit 132. A beam dump 152 can be connected to light outlet conduit 134 to terminate the light beam path. Laser pyrolysis can be performed with a variety of optical frequencies, using either a laser or other intense radiation source, such as a focused arc lamp. Some desirable light sources operate in the infrared portion of the electromagnetic spectrum, although other wavelengths can be used, such as the visible or ultraviolet regions of the spectrum. Excimer lasers can be used as intense ultraviolet light sources, and a variety of commercial lasers are available with lines in the visible. CO₂ lasers are particularly convenient sources of infrared light. Commercial CO₂ lasers are available in the watt to many kilowatts ranges. Suitable power meters are also commercially available for use as beam dump 152. Light delivery apparatus 122 can further comprise suitable optical components, such as mirrors, lenses, windows and the like. In particular, the light inlet path from intense light source 150 into reaction chamber 120 can comprise a cylindrical lens that focuses the light in one dimension, generally the dimension along the flow of the reactants, such that in the beam is thinner in the dimension shown in FIG. 1 along the flow of reactants from the bottom of the page toward the top of the page. In the embodiment of FIG. 1 with a cylindrical lens, the beam would not be focused perpendicular to the plane of the page so that a thicker flow of reactants can pass through the light beam to increase throughput.

Optional particle modifying section 126 delivers compositions and/or radiation into main chamber 120 to modify the flow of the product compositions, e.g., product particles. For example, a coating composition can be delivered to interface with the flow to coat product particles within the flow. Suitable coating compositions can be organic compositions, silicon based compositions or the like, such as surfactants and/or compositions that bond to the particle surfaces. With respect to the delivery of radiation, suitable radiation can include, for example, any reasonable radiation from available sources, such as light radiation, an electron beam or the like. The delivery of coating compositions to product particles in a laser pyrolysis apparatus is described further in published U.S. patent application 2007/0003694A to Chiruvolu et al., entitled “In-Flight Modification of Inorganic Particles Within a Reaction Product Flow,” incorporated herein by reference.

In additional or alternative embodiments, the modification composition can comprise an inert composition that modifies the thermal conditions to influence the properties of the particles, such as the crystallinity or particle size. Furthermore, the modification compositions can be selected to modify the surface chemistry of the particles. The delivery of compositions or radiation to modify the surface chemistry or the thermal conditions in the product flow of a laser pyrolysis apparatus is described further in copending U.S. patent application Ser. No. 12/077,076 to Holunga et al., entitled “Laser Pyrolysis With In-Flight Particle Manipulation for Powder Engineering,” incorporated herein by reference.

While main chamber 120 is shown in FIG. 1 with a single particle modifying section 126, the apparatus can be configured with a plurality of particle modifying sections if desired, each which may or may not be configured to deliver the same modifying composition/radiation. Each modification section can comprise a plurality of inlets to deliver the modifying composition configured around the inner circumference of the chamber to have approximate uniformity with respect to the flow, which may depend on the particular modification being performed. Similarly, radiation emitters can be appropriately distributed based on the configuration of the flow through the chamber.

Optional coating system 128 generally comprises a substrate holder 160, a translation element 162 and substrate 164. Substrate holder 160 generally is configured to support substrate 164 during a coating process in which product compositions are directly deposited onto substrate 164. For example, substrate holder 160 can comprise brackets, arms, suction components or the like for releasably supporting the substrate. Translation element 162 can be configured to translate substrate 164 through the product flow to coat the substrate. As described further below, in some embodiments, an elongated reactant flow results in an elongated product flow that deposits a line of product composition onto the substrate so that one scan of the substrate through the product flow can coat an entire substrate surface in a single pass through the product flow. While FIG. 1 schematically indicates the translation of substrate holder 160 relative to a fixed product flow, in some embodiments, the reactant nozzle and optical elements can be translated relative to a fixed substrate to scan the product flow across the substrate. Uniform coatings can be deposited onto substrates using light reactive deposition. Light reactive deposition is described further in Published U.S. patent applications 2003/0228415A to Bi et al., entitled “Coating Formation by Reactive Deposition,” 2005/0019504A to Bi et al., entitled “High Rate Deposition for the Formation of High Quality Optical Coatings,” and 2006/0134347A to Chiruvolu et al., entitled “Dense Coating Formation by Reactive Deposition,” all three of which are incorporated herein by reference.

Flow section 104 comprises a conduit 170 connecting main chamber 120 with collection system 106. In some embodiments, referring to FIG. 1, flow section 104 optionally comprises one or more modification elements 172 each involved with the delivery of a composition or interaction with radiation from a radiation source. Each inlet can be in fluid communication a composition supply element having a reservoir to deliver a vapor and/or aerosol comprising the desired composition. Suitable radiation sources include, for example, optical light sources, electron beam sources, or other suitable radiation sources. Modification elements 172 are essentially equivalent to modification sections 126 except for their placement within conduit 170 to place them further from the light reaction zone. The number of modification elements 172 and modification sections 126, their relative positioning and the configuration of individual modification elements and/or modification sections can be designed to achieve desired product composition properties.

Conduit 170 of flow section 104 can be distinguished from the laser pyrolysis apparatus 102 due to a change in direction of the flow or due to a change in cross sectional area available to the flow, such as a constriction. In some embodiments, there may not be a clear boundary between the laser pyrolysis apparatus 102 and flow section 104, and the boundary can be selected conceptually as convenient. A conduit of the flow section can be straight, or it can be curved to redirect the flow as appropriate to reach the collection system. In addition, the cross sectional dimensions may or may not remain relatively constant between the inorganic particle synthesis reactor and the flow/modification section, and the conduit can have a circular cross section over a portion of its length even if the reaction chamber and flow through the reaction chamber is elongated with a cross section having an aspect ratio significantly greater than 1.

Referring to FIG. 1, collection system 106 can comprise a collector 180, a negative pressure device 182 and a scrubber 184 with appropriate conduits connecting the flow between these components. Collector 180 can be, for example, a filter, a bag collector, an electrostatic collector or the like. Suitable filters include, for example, flat filters or cylindrical filters. In some embodiments, the collector can be a bag collector for continuous collection without disrupting particle production, such as described in U.S. Pat. No. 6,270,732 to Gardner et al., entitled Particle Collection Apparatus And Associated Methods, incorporated herein by reference. Suitable negative pressure devices include, for example, pumps, blowers, an aspirator/venturi, compressor, ejector or the like. Vacuum pumps are commercially available, such as available from Leybold Vacuum Products, Export, Pa. or a dry rotary pump from Edwards, such as model QDP80. Optional scrubber 184 can be used to remove environmentally harmful compounds from the filtered flow to reduce their release into the atmosphere. Suitable scrubbers include, for example, in-line Sodasorb® (W.R. Grace) chlorine traps.

The pressure in the reaction chamber generally can be measured with a pressure gauge. For example, a manometer can be used as a pressure gauge. Manometers provide accurate linear responses with respect to pressure. In some embodiments, the pressure gauge is connected to a controller. The controller can be used to monitor the pressure in reaction chamber and maintain the pressure in reaction chamber within a specified range using a feedback loop with the collection system. The operation of the feedback loop depends on the structural design of the collection system, and may involve, for example, the adjustment of a valve, pumping speed and/or filter pulsing rates, with automatic adjustment by the controller. Suitable automatic valves for interfacing with the controller are available from Edwards Vacuum Products, Wilmington, Mass. If manual values are used, the controller can notify an operator to adjust the manual valve appropriately.

Laser pyrolysis systems suitable for producing commercial quantities of product particles can have an inlet elongated along the direction of the light beam propagation such that a sheet of reactants flow into the reaction zone to form a sheet of inorganic product composition in a product flow downstream from the reaction zone. Generally, essentially the entire reactant flow passes through the light beam. Large throughputs are achievable with these systems, which are able to efficiently produce highly uniform product compositions over appropriately long run time. Referring to FIG. 1, reaction chamber 120 is configured with an elongated reactant inlet for the achievement of a higher throughput. When viewed from the top of the reaction chamber, the elongated inlet can appear as a slit or elongated rectangular opening, although the edges are not necessarily straight and the corners can be rounded or the like. In some embodiments, the inlet can have an aspect ratio of the longer length divided by the shorter width of at least about 2, in additional embodiments at least about 5, in further embodiments at least about 10 and in other embodiments at least about 20. If the inlet is not precisely rectangular, the length and width can be estimated approximately by a person of ordinary skill in the art based on the average length and width the inlet or using the length and width of a comparable rectangular inlet. A person of ordinary skill in the art will recognize that additional ranges of aspect ratios within the explicit ranges above are contemplated and are within the present disclosure. Reaction chamber designs for large throughputs are described further in U.S. Pat. No. 5,958,348 to Bi et al., entitled “Efficient Production of Particles By Chemical Reaction,” incorporated herein by reference.

A perspective view of a particular embodiment of a reaction chamber 190 is shown schematically in FIG. 2 with transparent walls for improved visualization. FIG. 2 shows reaction chamber 190 generating a sheet of product flow 192 from a sheet of reactant flow 194. This chamber is shown in this view truncated a short distance above the reaction zone. A rectangular reactant inlet 196 leads to main chamber 198. Reactant inlet 196 conforms generally to the shape of main chamber 198. Reactant inlet 196 is connected to a reactant delivery system. Shielding gas inlets 200 can be located on both sides of reactant inlet 196. Shielding gas inlets are used to form a blanket of gases, e.g., inert gases, on the sides of the reactant stream to inhibit contact between the chamber walls and the reactants or products.

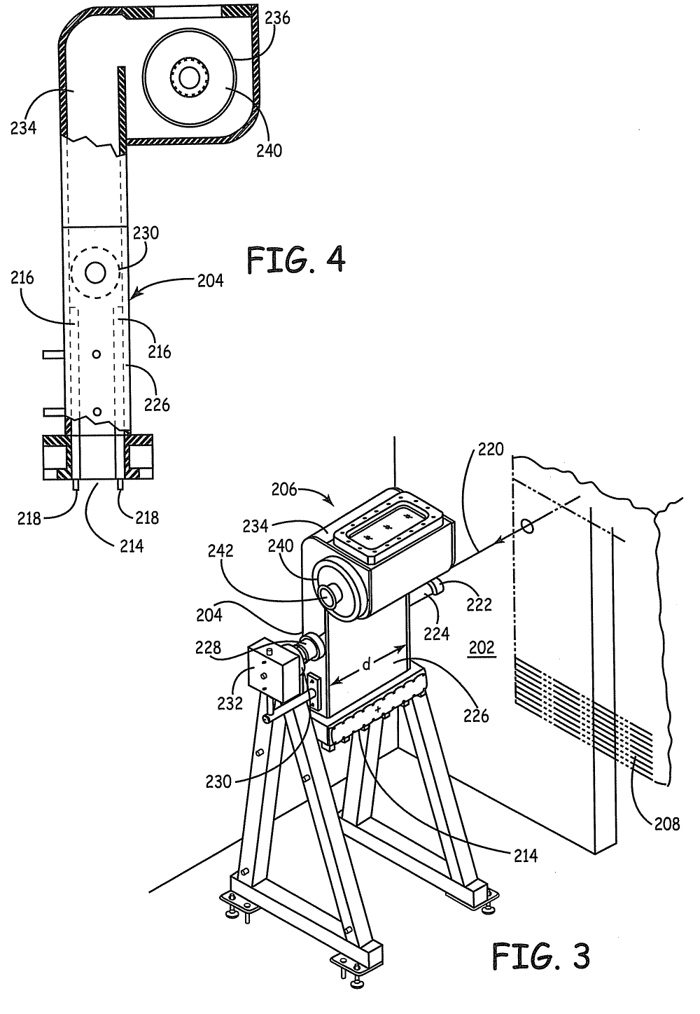

Another specific embodiment of a laser pyrolysis apparatus is shown in FIGS. 3 and 4. Referring to FIGS. 3 and 4, a laser pyrolysis reaction system 202 comprises reaction chamber 204, a particle collection system 206 and laser 208. Reaction chamber 204 comprises reactant inlet 214 at the bottom of reaction chamber 204 where a reactant delivery system connects with reaction chamber 204. In this embodiment, the reactants are delivered from the bottom of the reaction chamber while the products are collected from the top of the reaction chamber, although in alternative embodiments, this configuration of flow corresponding components can be reversed with reactants entering the chamber form the top and particles collected from the bottom. Shielding gas conduits 216 are located on the front and back of reactant inlet 214. Inert gas and/or other selected gases can be directed into shielding gas conduits through ports 218. The shielding gas conduits direct shielding gas along the inside walls of reaction chamber 204 to inhibit association of reactant gases or products with the walls.

Reaction chamber 402 is elongated along one dimension denoted in FIG. 3 by “d”. A laser beam path 220 enters the reaction chamber through a window 222 displaced along a tube 224 from the main chamber 426 and traverses the length of the reaction chamber 204. The laser beam passes through tube 228 and exits window 230. In one embodiment, tubes 224 and 228 displace windows 222 and 230 roughly 10-12 inches from the main chamber, although this distance can be adjusted based on the general parameters of the reactor. The laser beam terminates at beam dump 232. In operation, the laser beam intersects a reactant stream generated through reactant inlet 214.

The top of main chamber 226 opens into particle collection system 206. Particle collection system 206 comprises outlet duct 234 connected to the top of main chamber 226 to receive the flow from main chamber 226. Outlet duct 234 carries the product particles out of the plane of the reactant stream to a cylindrical filter 236, as shown in FIG. 4. Filter 236 has a seal on one end, and the other end of filter 236 is fastened to disc 240. A vent 242 is secured to the center of disc 240 to provide access to the center of filter 236. In use, vent 242 is attached by way of ducts to a pump or the like. Thus, product particles are trapped on filter 236 by the flow from the reaction chamber 204 to the pump.

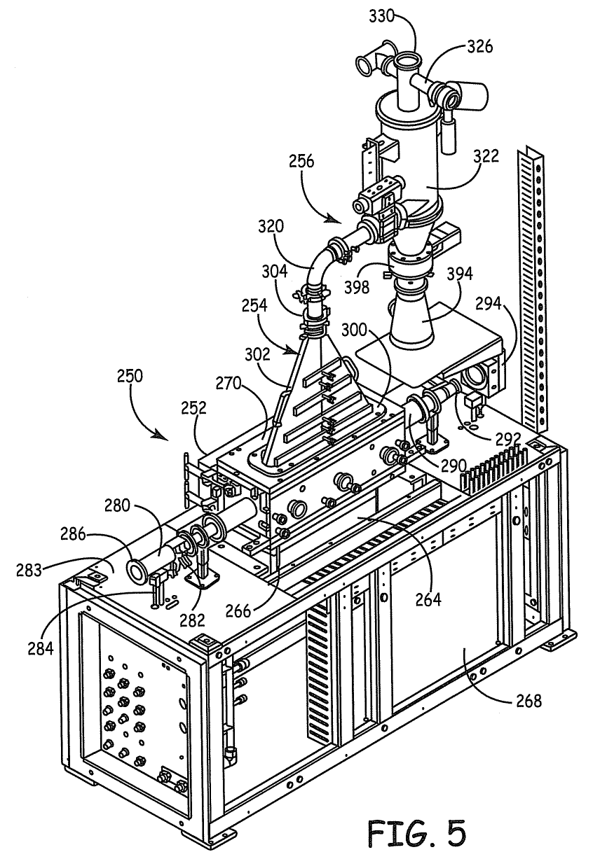

An alternative embodiment of an inorganic particle production system is shown in FIG. 5 with a flow section having a taper along one dimension. Referring to FIG. 5, a laser pyrolysis reaction system 250 includes reaction chamber 252, particle transfer element 254, and a particle collection system 256. Reaction chamber 252 interfaces with inlet nozzle 264 at a bottom surface 266 of reaction chamber 252 where reactant delivery system 268 connects with reaction chamber 252. Particle transfer element 254 connects along a top surface 270 with reaction chamber 252. In this embodiment, the reactants are delivered from the bottom of the reaction chamber while the products are collected from the top of the reaction chamber. Inlet nozzle 264 has a central reactant channel with shielding gas conduits adjacent the front and back of the central reactant channel similar to the configuration shown in FIG. 2.

First light tube 280 is configured to direct a light beam path through the reaction chamber along the length of the chamber. First light tube 280 comprises a cylindrical lens 282 oriented to focus along the direction oriented along a normal between the top surface 270 to the bottom surface 266 of reaction chamber 252 while not focusing the light along the direction parallel to table top 283. Inert gas is directed into first tube 480 from gas tubing 284 to keep the optical path clean. First light tube 280 connects directly or indirectly with a light source at flange 286. The light beam path continues through reaction chamber 250 to second light tube 290. Second light tube 290 terminated with a window 292 that directs the beam to a light meter/beam dump 294. In operation, the light beam, generally from a CO₂ laser, intersects a reactant stream generated from inlet nozzle 264. Particle transfer element 254 comprises attachment plate 300, flow conduit 302 and cooling collar 304. Attachment plate 300 provides for secure fastening of particle transfer element 254 to top plate 296. Cooling gas can be introduced at cooling collar to cool product particles prior to their arrival at the particle collector.

Cooling collar 304 leads into particle collection system 206. Particle collection system 206 comprises flow tube 320, collection chamber 322 and container 324. Flow tube 320 provides a fluid connection between cooling collar 304 and collection chamber 322. In this specific embodiment, collection chamber 322 is a single bag collector which uses a flexible bag to separate a product plenum from a clean plenum. Back pulse system 326 provides occasional back pulses of gas to removed product powders from the bag membrane so that the powders fall to the bottom of collection chamber 322. The bottom of collection chamber 324 is connected with valve 328 that is releasably connected to container 324. When valve 328 is open powder can fall into container 324. To remove and replace container 324, valve 328 can be closed. Collection chamber 324 also leads to a vent 330 that generally is connected to a scrubber and a pump. Other collection systems can be used in place of the single bag collector if desired.

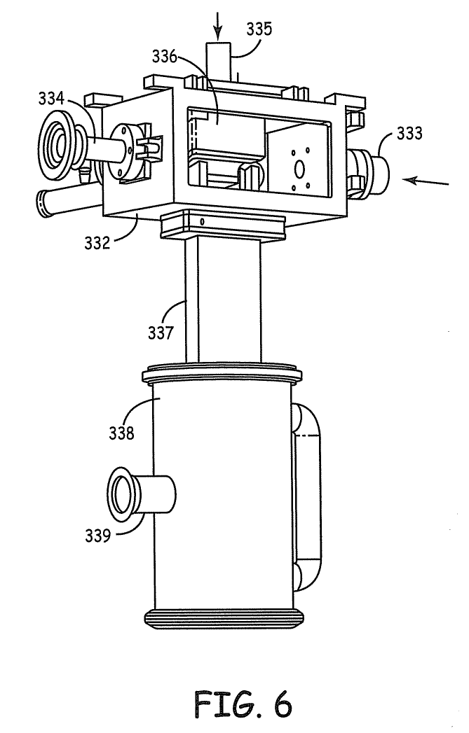

An embodiment of a light reactive deposition apparatus is shown in FIGS. 6-8. Referring to FIG. 6, reaction chamber 332 includes a light tube 333 connected to a CO₂ laser and a light tube 334 connected to a beam dump (not shown). An inlet tube 335 connects with a precursor delivery system that delivers vapor reactants and carrier gases. Inlet tube 335 leads to process nozzle 336. An exhaust transport tube 337 connects to process chamber 332 along the flow direction from process nozzle 336. Exhaust transport tube 337 leads to a filtration chamber 338. Filtration chamber 338 connects to a pump at pump connector 339.

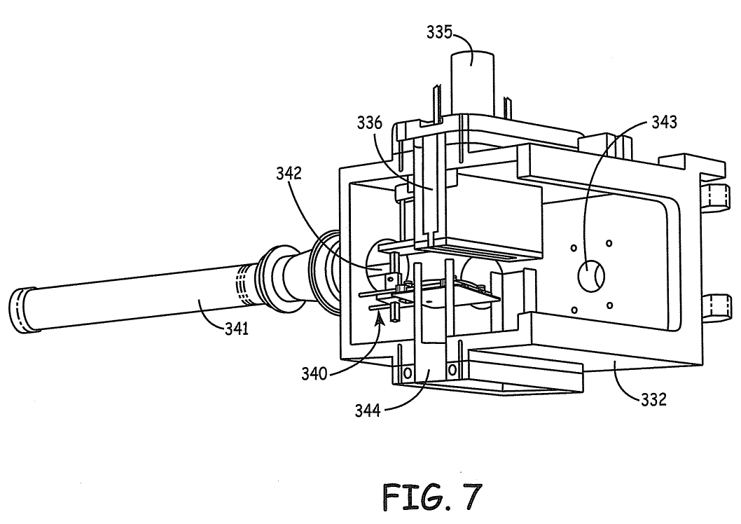

An expanded view of process chamber 332 is shown in FIG. 7. A substrate carrier 340 supports a substrate above process nozzle 336. Substrate carrier 340 is connected with an arm 341, which translates the substrate carrier to move the substrate through the product stream emanating from the reaction zone where the light beam intersects the precursor stream from process nozzle 336. Arm 341 comprises a linear translator 342 that is shielded with a tube. A light entry port 343 is used to direct a light beam between process nozzle 336 and the substrate. In this embodiment, unobstructed flow from process nozzle would proceed directly to exhaust nozzle 344, which leads to exhaust transport tube 337.

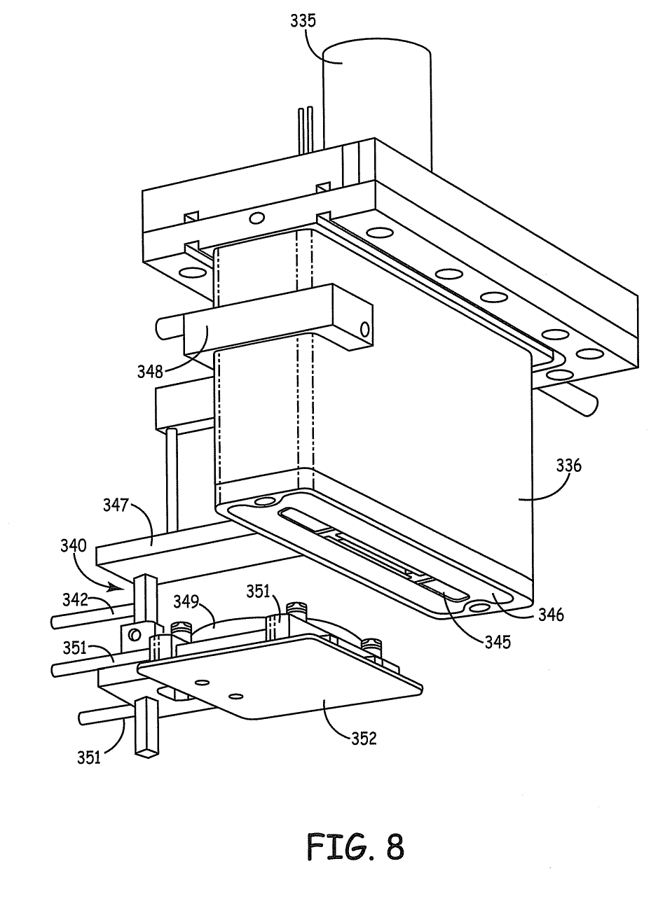

An expanded view of substrate carrier 340 and process nozzle 336 is shown in FIG. 8. The end of process nozzle 336 has an opening 345 for precursor delivery and a shielding gas opening 346 around precursor opening to confine the spread of precursor and product flow. Opening 345 can be appropriately configured with an aerosol generator with the particular configuration depending on the design of the particular aerosol generator. Substrate carrier 340 comprises a support 347 that connects to process nozzle 336 with a bracket 348. A wafer or other substrate 349 can be held in a mount 350 such that substrate 349 slides within mount 350 along tracks 351 to move substrate 349 into the product flow from the reaction zone. Backside shield 352 prevents uncontrolled deposition of product composition on the back of substrate 349. Tracks 351 connect to linear translator 342.

For any of the coating configurations, the intersection of the flow with the substrate deflects the trajectory of the flow. Thus, it may be desirable to select the position of the reaction chamber outlet or outlets to account for the change in direction of the flow due to the substrate, rather than placing the outlet in a direct line from the reactant inlet. For example, it may be desirable to alter the chamber design to direct the reflected flow to the outlet and/or to change the position of the outlet accordingly.

With respect to FIG. 1, in embodiments of particular interest, reactant delivery system 108 generally comprises an aerosol generator for the delivery of aerosol reactant precursors. As noted above with respect to the FIG. 1, reactant delivery system 108 generally is configured to interface with reactant inlet 124 to deliver a flow of reactants into main chamber 120. In general, similar reactant delivery systems can be used for the light driven reactor of FIG. 1 and the reactors in FIGS. 2-8 appropriately adjusted for the size of the reaction chambers and other apparatus parameters. In general, additional reactants, light absorbing gases and/or inert gases can be delivered in conjunction with the aerosol as well as optionally through independent inlets for blending with the aerosol.

With respect to reactant delivery generally, many precursor compositions, such as metal/metalloid precursor compositions, can be delivered into the reaction chamber as a gas/vapor. Appropriate precursor compositions for gaseous delivery generally include compositions with reasonable vapor pressures, i.e., vapor pressures sufficient to get desired amounts of precursor gas/vapor into the reactant stream. The vessel holding liquid or solid precursor compositions can be heated to increase the vapor pressure of the precursor, if desired. Solid precursors generally are heated to produce a sufficient vapor pressure. In some embodiments, a carrier gas can be bubbled through a liquid precursor to facilitate delivery of a desired amount of precursor vapor. Similarly, a carrier gas can be passed over a solid precursor to facilitate delivery of the precursor vapor. Alternatively or additionally, a liquid precursor can be directed to a flash evaporator to supply a composition at a selected vapor pressure. The use of a flash evaporator to control the flow of non-gaseous precursors can provide a high level of control on the precursor delivery into the reaction chamber. However, the ability to deliver an aerosol of reactant precursors significantly expands the range of available precursor compositions that can be delivered into the reactant zone, which can provide significant flexibility for producing product inorganic compositions.

Also, secondary reactants can be used in some embodiments to alter the oxidizing/reducing conditions within the reaction chamber and/or to contribute non-metal/metalloid elements or a portion thereof to the reaction products. The particles, in some embodiments, further comprise one or more non-(metal/metalloid) elements. For example, some compositions of interest are oxides, nitrides, carbides, sulfides or combinations thereof. For the formation of oxides, an oxygen source should also be present in the reactant stream, and other appropriate sources of non-(metal/metalloid) elements can be supplied to form the other compositions.

Suitable secondary reactants serving as an oxygen source for the formation of oxides include, for example, O₂, CO, N₂O, H₂O, CO₂, O₃ and the like and mixtures thereof. Molecular oxygen can be supplied as air. Suitable secondary reactants for the formation of nitrides include, for example, NH₃ and/or N₂. In some embodiments, the metal/metalloid precursor compositions comprise oxygen or other non-(metal/metalloid) element such that all or a portion of the oxygen or other element in product particles is contributed by the metal/metalloid precursors. Similarly, liquids used as a solvent/dispersant for aerosol delivery can similarly contribute secondary reactants, e.g., oxygen, to the reaction. In other words, if one or more metal/metalloid precursors comprise oxygen and/or if a solvent/dispersant comprises oxygen, a separate secondary reactant, e.g., a vapor reactant, may not be needed to supply oxygen for product particles. The conditions in the reactor should be sufficiently oxidizing to produce the metal/metalloid oxide particles.

Generally, a secondary reactant composition should not react significantly with the metal/metalloid precursor(s) prior to entering the radiation reaction zone since this can result in the formation of larger particles and/or damage the inlet nozzle. Similarly, if a plurality of metal/metalloid precursors is used, these precursors should not significantly react prior to entering the radiation reaction zone. If the reactants are spontaneously reactive, a metal/metalloid precursor and the secondary reactant and/or different metal/metalloid precursors can be delivered in separate reactant inlets or nozzles into the reaction chamber such that they are combined just prior to reaching the light beam.

Infrared absorber(s) for inclusion in the reactant stream include, for example, C₂H₄, isopropyl alcohol, NH₃, SF₆, SiH₄ and O₃. O₃ and isopropyl alcohol can act as both an infrared absorber and as an oxygen source. The radiation absorber(s), such as the infrared absorber(s), can absorb energy from the radiation beam and distribute the energy to the other reactants to drive the pyrolysis.

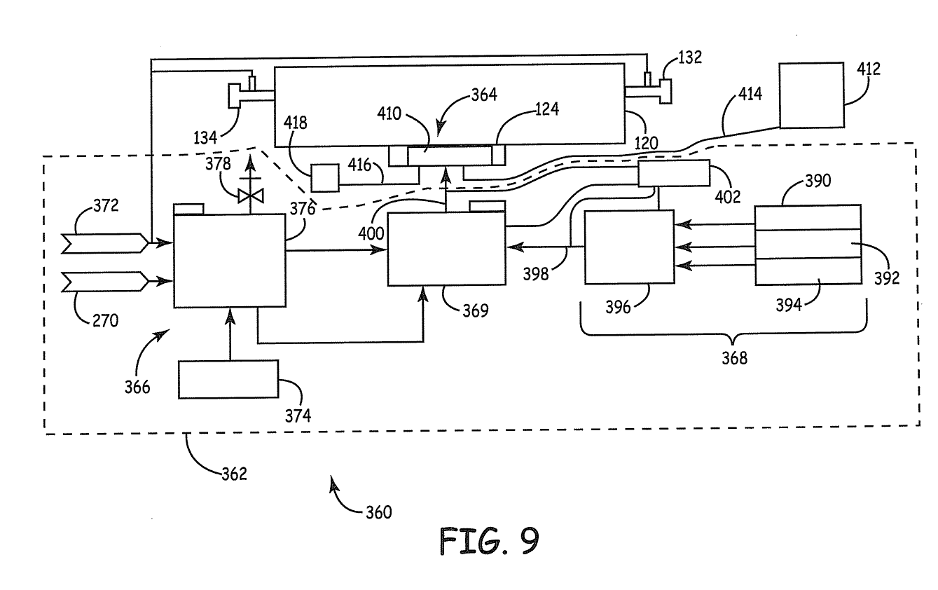

Referring to FIG. 9, an embodiment of a reactant delivery system 360 is shown schematically interfaced with reactant inlet into main chamber 120 (FIG. 1). As shown in FIG. 9, reactant delivery system 360 comprises a vapor/gas delivery unit 362 interfaced with an aerosol unit 364. For embodiments of light driven reactors involving a plurality of metal/metalloid elements and an apparatus with an aerosol generator, the metal/metalloid elements can be delivered all as aerosol precursors or as a combination of vapor or gas precursors and aerosol precursors. If a plurality of metal/metalloid elements is delivered as an aerosol, the precursors can be dissolved/dispersed within a single solvent/dispersant for delivery into the reactant flow as a single aerosol. Alternatively, the plurality of metal/metalloid elements can be delivered within a plurality of solutions/dispersions that are separately formed into an aerosol that are subsequently combined in the reactant flow at or before the light reaction zone. The generation of a plurality of aerosols can be helpful if convenient precursors are not readily soluble/dispersible in a common solvent/dispersant. While a plurality of aerosols can be introduced into a common gas flow for delivery into the reaction chamber through a common nozzle, if the aerosol generators are placed closer to the light reaction zone, a plurality of reactant inlets can be used for the separate delivery of aerosol and/or vapor reactants into the reaction chamber such that the reactants mix within the reaction chamber prior to or at entry into the reaction zone. Multiple reactant inlets for delivery into a laser pyrolysis chamber are described further in Published U.S. Patent Application 2002/0075126A to Reitz et al., entitled “Multiple Reactant Nozzle For A Flowing Reactor,” incorporated herein by reference.

The embodiment of reactant delivery system 360 in FIG. 9 accounts for various options with respect to the delivery of precursors. Gas/vapor delivery unit 362 can comprise a gas delivery subsystem 366 and a vapor delivery subsystem 368 that both join a mixing subsystem 369. In some embodiments, a vapor subsystem is not used to deliver vapor reactants if the desired metal/metalloid precursors are delivered as an aerosol. Gas delivery subsystem 366 can comprise one or more gas sources, such as a gas cylinder or the like for the delivery of gases into the reaction chamber. As shown schematically in FIG. 9, gas delivery subsystem 366 optionally comprises reactant gas source 370, inert gas source 372, a light absorbing gas source 374 or a combination thereof. In other embodiments, the gas delivery subsystem can comprise a different number of gas sources such that desired reactant gases and/or other gases can be selected as desired.

The gases combine in a gas manifold 376 where the gases can mix. Gas manifold 376 can have a pressure relief valve 378 for safety. Inert gas source 372 can be also used to supply inert gas within tubular sections 132, 134 used to direct light into and from main chamber 120. Mass flow controllers can be used to regulate the flow of gases to gas manifold 376.

Vapor delivery subsystem 368 can comprise a plurality of flash evaporators 390, 392, 394. Although shown with three flash evaporators, vapor delivery subsystem can comprise, for example, one flash evaporator, two flash evaporators, four flash evaporators or more than four flash evaporators to provide a desired number of vapor precursors that can be selected for delivery into the reactor to form desired inorganic particles. Each flash evaporator can be connected to a liquid reservoir to supply liquid precursor in suitable quantities. Suitable flash evaporators are available from, for example, MKS Equipment or can be constructed from readily available components. The flash evaporators can be programmed to deliver a selected partial pressure of the particular precursor. The vapors from the flash evaporator are directed to a manifold 396 that directs the vapors to a common feed line 398. The vapor precursors mix within manifold 396 and common feed line 398. A flash evaporator can be replaced by a solid precursor delivery apparatus, which can heat a solid to generate a vapor that can then be delivered with a carrier gas if desired. The carrier gas can be, for example, an infrared absorber, a secondary reactant, an inert gas or mixtures thereof.

The gas compositions from gas delivery subsystem 366 and vapor compositions from vapor delivery subsystem 368 are combined within mixing subsystem 369. Mixing subsystem 369 can be a manifold that combines the flow from gas delivery subsystem 366 and vapor delivery subsystem 368. In the mixing subsystem 369, the inputs can be oriented to improve mixing of the combined flows of different vapors and gases at different pressures. The mixing block can have a slanted termination to reduce backflow into lower pressure sources. A conduit 370 leads from mixing subsystem 369 to reaction chamber 120.

Referring to FIG. 9, a heat controller 402 can be used to control the temperature of various components through conduction heaters or the like throughout the vapor delivery subsystem 368, mixing subsystem 369 and/or conduit 400 to reduce or eliminate any condensation of precursor vapors. A suitable heat controller is model CN132 from Omega Engineering (Stamford, Conn.). Overall precursor flow can be controlled/monitored by a DX5 controller from United Instruments (Westbury, N.Y.). The DX5 instrument can be interfaced with mass flow controllers (Mykrolis Corp., Billerica, Mass.) controlling the flow of one or more vapor/gas precursors. The automation of the unit can be integrated with a controller from Brooks-PRI Automation (Chelmsford, Mass.).

In general, a reactant delivery system can be configured to deliver a selected reactant composition based on a supply with a range of precursors and other reactants to tune a particular inorganic particle composition without refitting the unit since a number of precursors supplies can be integrated together within the unit simultaneously. For the formation of complex materials and/or doped materials, a significant number of reactant sources and, optionally, separate reactant ducts can be used for reactant/precursor delivery. For example, as many as 25 reactant sources and/or ducts are contemplated, although in principle, even larger numbers could be used.

Aerosol unit 364 can comprise aerosol generator 410, liquid supply 412, liquid transfer conduit 414 connecting liquid supply 412 to aerosol generator 410, drain tube 416 and drain reservoir 418. Liquid supply 412 and drain reservoir 418 can comprise any suitable container or the like, such as stainless steel containers. Similarly, liquid transfer conduit 414 and drain tube 416 can be formed from any suitable material, such as stainless steel tubing, with a diameter appropriate for the volumes of liquid to be transported.

As noted above, it is desirable for the precursor reactant aerosol to comprise small uniform droplets or particles. Droplets generally refer to a drop in the flow comprising a liquid, although a droplet can comprise particulates and solvent can evaporate from a droplet in flight. In some embodiments, the aerosol droplets have an average diameter of no more than about 50 microns, in other embodiments no more than about 15 microns, in further embodiments no more than about 10 microns and in additional embodiments, from about 20 nanometers to about 1 micron. Also, the aerosol droplets can have a uniformity such that no more than 1 droplet in 10,000 has a diameter greater than 5 times the average diameter A person of ordinary skill in the art will recognize that additional ranges of average particle size and uniformity within the explicit ranges above are contemplated and are within the present disclosure.

Furthermore, the average speed of the droplets can be controlled to be low enough to provide for placement of the aerosol generator near the light reaction zone while providing desired velocity through the reaction zone. The velocity should be great enough to prevent flash back into the aerosol generator. In some embodiments, the droplets adjacent the aerosol generator have an average velocity of no more than about 5 meters per second (m/s), in other embodiments no more than about 2 m/s, in additional embodiment no more than about 1 m/s, in some embodiments no more than about 50 centimeters per second (cm/s), and in further embodiments from about 15 cm/s to about 40 cm/s. In some embodiments, the aerosol generation parameters and/or entrainment gas properties can be adjusted to select an average aerosol velocity within the described ranges. For these embodiments, the aerosol generation surface can be placed within about 6 centimeters from the edge of the light beam and in further embodiments within about 4 centimeters of the light beam. A person of ordinary skill in the art will recognize that additional ranges of aerosol velocity and aerosol generator placement are contemplated and are within the present disclosure. Furthermore, the aerosol generators can be designed to provide shaped aerosol flows to provide greater throughput through the light beam. Similarly, the reactor can comprise a plurality of aerosol generators distributed along the light beam path to also provide greater throughput through the light beam.

Liquids for delivery in the aerosol can include, for example, liquid solutions, liquid blends, neat liquids and dispersions. Liquid solutions can involve any reasonable solvent or blends thereof. Suitable solvents include, for example, water, but other solvents such as other inorganic solvents, alcohols, hydrocarbons, and other organic solvents, blends thereof and/or blends with water can be used, if appropriate. A reactant, such as vanadium oxytrichloride, or a light (laser) absorbing compound, such as isopropyl alcohol, can serve as a solvent for additional reactants. If the solvent is a light absorbing compound, an additional light (laser) absorbing compound may not be needed. In some embodiments, separate light absorbing compositions are used, such as ethylene, C₂H₄, which absorbs infrared light from a CO₂ laser.

A solution for aerosol delivery generally can have a concentration greater than about 0.5 molar. Higher concentrations lead to greater reactant throughput in the reaction chamber. Higher concentration solutions, however, can lead to liquids that are too viscous for convenient formation into an aerosol or that form aerosol droplets with undesirably large sizes or with a broad range of droplet sizes, depending on the properties of the aerosol generator. Thus, solution concentration is another parameter to consider with respect to obtaining desired properties of the reaction product.

If the embodiment of the reactant delivery system comprises a plurality of inorganic particle precursor inlets, flow from these can be combined prior to inorganic particle production, which can involve, for example, the combination of reactants that are difficult to deliver through a single nozzle or of reactant that are reactive upon mixing so that they do not react significantly prior to entering the light reactive zone. A plurality of inlets can be configured such that the flows form the inlets mix prior to the reactant flow entering the light reactive zone. Similarly, inlets comprising vapor or gaseous reactants can be configured to mix with an aerosol flow from one or more inlets configured to deliver aerosol into the reaction chamber. The number of precursor inlets can be selected based on the selected reactant precursors and the desired product compositions.

In general, suitable aerosol generators can include, for example, an ultrasonic generator, an electrostatic spray system, a pressure-flow atomizer, an effervescent atomizer, a gas atomizer, a pressure flow atomizer, a spill-return atomizer, a gas-blast atomizer, a two fluid internal mix atomizer, a simplex atomizer, a two fluid external mix atomizer, a Venturi-based atomizer or combination thereof. As described herein, it is desirable to deliver specific aerosols with small droplet sizes and/or a high degree of droplet size uniformity. The particle size distribution can be measured using, for example, laser diffraction, and suitable commercial measurement apparatuses are available from Malvern Instruments Ltd. (UK), such as their Spraytec™ system.

Small and uniform aerosol droplets or particles can be generated with commercially available aerosol generators, such as an Aeroneb® Go (OnQ®) from Aerogen Inc., Ireland, a 2.4 MHz nebulizer from Sonaer Ultrasonics (Sonaer Inc, Farmingdale, N.Y.), and a pneumatic nebulizer form Burgener Research Inc, Ontario Canada. Also, suitable aerosol generators for producing more uniform and/or smaller droplets are described, for example, in U.S. Pat. No. 5,858,313 to Park et al., entitled “Aerosol Generator and Apparatus for Producing Small Particles,” and published PCT application WO 02/056988A to Ultrasonic Dryer Ltd. (the '988 application), entitled “Method and Apparatus for Production of Droplets,” both of which are incorporated herein by reference. The aerosol generation approach of the '988 application can be adapted for particular suitability for the high throughput laser pyrolysis reactors described herein. This design of an aerosol generator can be described as a surface fogging aerosol generator.

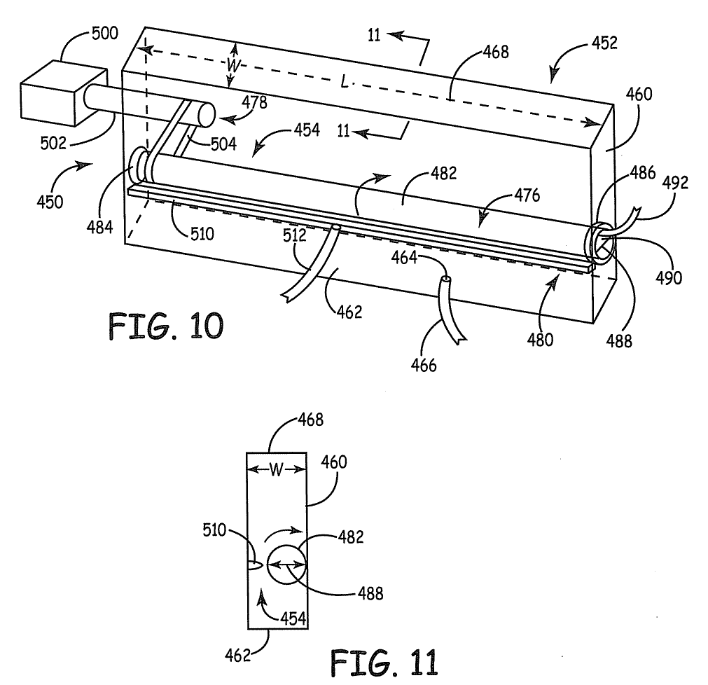

A specific design of a surface fogging aerosol generator for use with the laser pyrolysis reactors directly produces an aerosol suitable for an elongated reactant inlet, which can have a relatively large aspect ratio, as well as providing continuous operation. Referring to FIGS. 10 and 11, surface fogging aerosol generator 450 comprises chamber 452 and mist generator 454. Chamber 452 comprises walls 460, floor 462 and drain 464 that connects with drain tube 466. Walls 460 constrain the gas flow to direct the gas flow through top opening 468. Top opening 468 can be considered the edge of the aerosol generator with respect to placement of the aerosol generator since the opening indicated the initiation of unconstrained aerosol flow. Top opening 468 can be positioned near the light reaction zone as desired. Also, top opening 468 can be designed with the desired aspect ratio with the length, l, and width, w, noted in FIG. 10. A sectional view is shown in FIG. 11.

Mist generator 454 comprises rotatable element 476, drive system 478 and liquid delivery element 480. Rotatable element 476 comprises porous cylinder 482, mount 484, accessed mount 486 and gasket 488. Porous cylinder 482 comprises a gas permeable material, such as metal, ceramic, polymer or a combination thereof. In general, the thickness of the porous structure can be 1.5 mm to 2.5 mm, and the pore size can be about 50 nm to about 5 microns, and in further embodiments from about 100 nm to about 2 microns. The porosity can be from about 5 percent to about 50 percent, and in other embodiments from about 7 percent to about 36 percent, where porosity represents the portion of the surface area exposed at pores. A person of ordinary skill in the art will recognize that additional ranges of thickness, average pore size and porosity within the explicit ranges above are contemplated and are within the present disclosure. Porous structures for generative mist are described further in the '988 application.

Mount 484 provides for low friction rotation of one end of porous cylinder 482. Mount 484 can comprise ball bearings or other bearingless design that provides for a desired low level of friction. Accessed mount 486 comprises a low friction support providing for the rotation of porous cylinder 482 with a fixed end cap 490 that seals the top half of porous cylinder 482 with a connection to a gas/vapor tube 492. A comparable end cap (not shown) generally without a tubular connection is located at the other end of cylinder 482. End cap 490 and the end cap (not shown) at the other end of the cylinder seal the top half of porous cylinder 482 as the rotatable cylinder can freely rotate. Gasket 488 extends the length of porous cylinder 482 and is fixed at both ends to remain in a fixed orientation along with the end caps as porous cylinder 482 rotates. Gasket 488 can comprise low friction edges that form a seal between the top half and the bottom half of cylinder 482. Gasket 488 can comprise, for example, silicone polymer, Teflon®, or other suitable polymer. Thus, gas/vapor delivered from tube 492 pressurizes the top half of porous cylinder 482 while the tube can rotate relative to fixed gasket 488 and end cap 490. In some embodiments, the gasket can divide the interior of the cylinder to isolate a different portion than the top half of the cylinder for exposure to gas/vapor delivery, such as a small portion or a larger portion than the top half of the cylinder.

Drive system 478 can comprise any suitable device to rotate porous cylinder 482 at a selected speed of rotation. Referring to FIG. 10, drive system 478 comprises a motor 500, axel 502 and drive belt 504. Motor 500 rotates axel 502 which correspondingly rotates porous cylinder 482. Drive belt 504 can be replaced with a gear drive, if desired. Similarly, a direct drive system can be used in which mount 484 can be replaced with a direct attachment to an appropriate motor.

Liquid delivery element 480 comprises an elongated applicator element 510 operably connected to a liquid delivery tube 512. Applicator element 510 is configured to deliver liquid to the surface of porous cylinder 482 along the length of the cylinder. Applicator element 510 can deliver a spray or stream of liquid for the delivery of a desired amount of liquid along the surface. Liquid delivery tube 512 generally is connected to a reservoir of desired precursor liquid that is delivered to the porous cylinder for formation of an aerosol. Liquid delivery element 480 delivers a film of liquid along the surface of porous cylinder 482 as porous cylinder rotates past the element. The film rotates along the top surface of the cylinder where the inner portion of cylinder has pressurized gas. As the gas flows out form the cylinder through the pores, the liquid film is converted to a mist that flows with the gas from chamber 452 to form an aerosol exiting from the device. While applicator element 510 is shown in FIGS. 10 and 11 in a horizontal orientation relative to cylinder 482, applicator element 510 can be positioned somewhat higher or lower relative to cylinder 510 to obtain desired performance.

### Product Properties and Applications

The performance of the light driven reactive process can be used to produce coatings and/or submicron particles with a selected composition from a broad range of available compositions. Specifically, the compositions can comprise one or more metal/metalloid elements forming a crystalline or amorphous material with an optional dopant composition. In particular, inorganic product compositions can comprise, for example, elemental metal/metalloid, and metal/metalloid compositions, such as, metal/metalloid oxides, metal/metalloid carbides, metal/metalloid nitrides, metal/metalloid phosphides, metal/metalloid sulfides, metal/metalloid tellurides, metal/metalloid selenides, metal/metalloid arsinides, mixtures thereof, alloys thereof and combinations thereof. In addition, dopant(s)/additive(s) can be used to alter the optical, chemical and/or physical properties of the product compositions.

In general, the submicron/nanoscale inorganic product compositions can generally be characterized as comprising a composition comprising a number of different elements and present in varying relative proportions, where the number and the relative proportions can be selected as a function of the application for the particles. Typical numbers of different elements include, for example, numbers in the range(s) from about 2 elements to about 15 elements, with numbers of 1, 2, 3, 4, 5, 6, 7, 8, 9, 10, 11, 12, 13, 14, and 15 being contemplated, in which some or all of the elements can be metal/metalloid element. General numbers of relative proportions include, for example, ratio values in the range(s) from about 1 to about 1,000,000, with numbers of about 1, 10, 100, 1000, 10000, 100000, 1000000, and suitable sums thereof being contemplated. In addition, elemental materials are contemplated in which the element is in its elemental, un-ionized form, such as a metal/metalloid element, i.e., M⁰.

Alternatively or additionally, the product compositions can be characterized as having the following formula:

AₐB_{b}C_{c}D_{d}EₑF_{f}G_{g}HₕIᵢJⱼKₖLₗMₘNₙOₒ,

where each A, B, C, D, E, F, G, H, I, J, K, L, M, N, and O is independently present or absent and at least one of A, B, C, D, E, F, G, H, I, J, K, L, M, N, and O is present and is independently selected from the group consisting of elements of the periodic table of elements comprising Group 1A elements, Group 2A elements, Group 3B elements (including the lanthanide family of elements and the actinide family of elements), Group 4B elements, Group 5B elements, Group 6B elements, Group 7B elements, Group 8B elements, Group 1B elements, Group 2B elements, Group 3A elements, Group 4A elements, Group 5A elements, Group 6A elements, and Group 7A elements; and each a, b, c, d, e, f, g, h, i, j, k, l, m, n, and o is independently selected and stoichiometrically feasible from a value in the range(s) from about 1 to about 1,000,000, with numbers of about 1, 10, 100, 1000, 10000, 100000, 1000000, and suitable sums thereof being contemplated. The materials can be crystalline, amorphous or combinations thereof. In other words, the elements can be any element from the periodic table other than the noble gases. Elements from the groups Ib, IIb, IIIb, IVb, Vb, VIb, VIIb and VIIIb are referred to as transition metals. In addition to the alkali metals of group I, the alkali earth metals of group II and the transition metals, other metals include, for example, aluminum, gallium, indium, thallium, germanium, tin, lead, bismuth and polonium. The non-metal/metalloid elements include hydrogen, the noble gases, carbon, nitrogen, oxygen, fluorine, sulfur, chlorine, selenium, bromine, and iodine. As described herein, all inorganic compositions are contemplated, as well as all subsets of inorganic compounds as distinct inventive groupings, such as all inorganic compounds or combinations thereof except for any particular composition, group of compositions, genus, subgenus, alone or together and the like.

While some compositions are described with respect to particular stoichiometries/compositions, stoichiometries generally are only approximate quantities. In particular, materials can have contaminants, defects and the like. Similarly, some amorphous materials can comprise essentially blends such that the relative amounts of different components are continuously adjustable over ranges in which the materials are miscible. In other embodiments, phase separated amorphous materials can be formed with differing compositions at different domains due to immiscibility of the materials at the average composition. Furthermore, for amorphous and crystalline materials in which metal/metalloid compounds have a plurality of oxidation states, the materials can comprise a plurality of oxidation states.

In addition, particles can comprise one or more dopants/additives within an amorphous material and/or a crystalline material. An inorganic composition generally comprises a dopant in the range no more than about 15 mole percent of the metal/metalloid in the composition, in further embodiments in the range no more than about 10 mole percent, in some embodiments in the range from about 0.001 mole percent to about 5 mole percent, and in other embodiments in the range from about 0.025 to about 1 mole percent of the metal/metalloid in the composition. A person of ordinary skill in the art will recognize that additional ranges within the explicit ranges of dopant concentrations are contemplated and the present disclosure similarly covers ranges within these specific ranges.

Powders, e.g., collections of inorganic particles, can be formed with complex compositions including, for example, one or more metal/metalloid elements in a host material and, optionally, one or more selected dopants/additives. With the light driven reaction process, product materials can be formed with desired compositions by appropriately introducing a reactant composition to form the desired reaction product. Specifically, selected elements can be introduced at desired amounts by varying the composition of the reactant stream. The conditions in the reactor can also be selected to produce the desired product compositions.

With respect to laser pyrolysis, the production of a large range of inorganic particle compositions has been described. For example, the production of a range of submicron inorganic particles are described in Published U.S. Patent Application 2003/0203205 to Bi et al., entitled Nanoparticle Production and Corresponding Structures,” incorporated herein by reference. Specifically, this published application specifically references production of submicron particles with compositions such as amorphous SiO₂, anatase and rutile TiO₂, MnO, Mn₂O₃, Mn₃O₄ and Mn₅O₈, vanadium oxide with various stoiciometries, silver vanadium oxide, lithium manganese oxide with various stoichiometries, lithium cobalt oxide, lithium nickel oxide, lithium cobalt nickel oxide, lithium titanium oxide and other lithium metal oxides, aluminum oxide submicron/nanoscale, tin oxide, zinc oxide, rare earth metal oxide, rare earth doped metal/metalloid oxide, α-Fe, Fe₃C, and Fe₇C₃, iron oxide, silver metal, iron sulfide (Fe₁₋ₓS), metal phosphate, silicon carbide, silicon nitride and other compositions.

In particular, aerosol based laser pyrolysis particle production has been found to be effective at producing submicron particles, on particular, submicron metal oxide and metal phosphate particles for battery applications. These materials and applications are described further, for example, in U.S. Pat. No. 6,136,287 to Home et al., entitled “Lithium Manganese Oxides and Batteries,” U.S. Pat. No. 6,749,648 to Kumar et al., entitled “Lithium Metal Oxides,” and published U.S. Patent application 2002/0192137A to Chaloner-Gill, entitled “Phosphate Powder Compositions and Methods for Forming Particles with Complex Anions,” all three of which are incorporated herein by reference. In addition, aerosol-based laser pyrolysis has been useful for the production of doped phosphor compositions, as described further in U.S. Pat. No. 6,692,660 to Kumar, entitled “High Luminescent Phosphor Particles and Related Particle Compositions,” incorporated herein by reference. Furthermore, aerosol laser pyrolysis has been successful for the synthesis of doped amorphous particles that can be useful for optical applications, as described further in U.S. Pat. No. 6,849,334 to Home et al., “entitled Optical Materials and Optical Devices,” incorporated herein by reference.

Furthermore, a coating deposition process has been developed that adapts similar reactant delivery and light-drive reaction as used in laser pyrolysis. This technology, which has been termed Light Reactive Deposition or LRD™, is described further in published U.S. Patent application 2003/0228415A to Bi et al., entitled “Coating Formation by Reactive Deposition,” incorporated herein by reference. The aerosol delivery approaches described herein can be adapted for light reactive deposition based on the disclosure herein.

With respect to particle formation using a light driven reaction, the inorganic particles generally have an average diameter of no more than about one micron. A collection of submicron/nanoscale particles may have an average diameter for the primary particles of no more than about 500 nm, in some embodiments no more than about 250 nm, in further embodiments from about 2 nm to about 100 nm, alternatively from about 2 nm to about 75 nm, or from about 2 nm to about 50 nm. A person of ordinary skill in the art will recognize that other ranges within these specific ranges are contemplated and are within the present disclosure. Particle diameters are evaluated by transmission electron microscopy. For non-spherical particles, diameter measurements on particles are based on an average of length measurements along the principle axes of the particle.

The primary particles can have a roughly spherical gross appearance, or they can have rod shapes, plate shapes or other non-spherical shapes. Upon closer examination, crystalline particles may have facets corresponding to the underlying crystal lattice. Amorphous particles generally can have a spherical aspect. In some embodiments, the particles can have average aspect ratios of the longest length along a principle axis to the shortest distance along a principle axis of the particle is no more than about 2 and in further embodiments no more than about 1.5. A person of ordinary skill in the art will recognize that additional ranges of aspect ratios within the explicit ranges are contemplated and are within the present disclosure.

The particles generally have a surface area corresponding to particles on a submicron scale as observed in the micrographs. Furthermore, the particles can manifest unique properties due to their small size and large surface area per mass of material. For example, by UV-visible spectroscopy, the absorption spectrum of crystalline, nanoscale TiO₂ particles is shifted relative to the absorption spectrum of bulk TiO₂ particles.

The primary particles can have a high degree of uniformity in size. Laser pyrolysis generally results in particles having a very narrow range of particle diameters. With aerosol delivery of reactants for laser pyrolysis, the distribution of particle diameters is particularly sensitive to the reaction conditions. Nevertheless, if the reaction conditions are properly controlled, a very narrow distribution of particle diameters can be obtained with an aerosol delivery system. The improved aerosol delivery approaches described herein provide for uniform particles at higher particle production rates. As determined from examination of transmission electron micrographs, the primary particles generally have a distribution in sizes such that at least about 95 percent, and in other embodiments at least about 99 percent, of the primary particles have a diameter at least about 40 percent of the average diameter and no more than about 160 percent of the average diameter. In further embodiments, the primary particles have a distribution of diameters such that at least about 95 percent, and in other embodiments at least about 99 percent, of the primary particles have a diameter at least about 60 percent of the average diameter and no more than about 140 percent of the average diameter. A person of ordinary skill in the art will recognize that other ranges within these specific ranges are contemplated and are covered by the disclosure herein.

Furthermore, in preferred embodiments no primary particles have a diameter greater than about 5 times the average diameter, in other embodiments no more than about 4 times the average diameter and in further embodiments no more than about 3 times the average diameter. In other words, the particle size distribution effectively does not have a tail indicative of a small number of particles with significantly larger sizes. This is a result of the small reaction region and corresponding rapid quench of the particles. An effective cut off in the tail of the size distribution indicates that there are less than about 1 particle in 10⁶ have a diameter greater than a specified cut off value above the average diameter. High particle uniformity can be exploited in a variety of applications. In particular, high particle uniformity can lead to well controlled properties, such as optical properties.

As used herein, primary particles and primary particle size refer to particles and their size, that do not display any visible necking on a transmission electron micrograph. Such particles are in principle dispersible under appropriate conditions. However, it may not be possible to ideally disperse the particles completely even if there is no visible necking that is hard-fusing the particles. Since techniques do not provide for observing the individual particles in dispersions the details of the dispersion process are necessarily somewhat incompletely understood. However, the size of the dispersed particles, as measured by dynamic light scattering measurements, may approach the size observed in TEM micrographs and/or BET surface area characterization.

Secondary particle size refers to the size of dispersed particles in a fluid. The secondary particle sizes can be measured with techniques such as light scattering and the like. Commercial instruments can be used to measure the particle sizes in dispersions. In general, the secondary particle size can be the same order of magnitude as the primary particle size. In some embodiments, the average secondary particle size can be less than a factor of five times the average primary particle size and in further embodiments no more than a factor of three larger than the average primary particle size.

In addition to the uniformity of the inorganic particles, the inorganic particles may have a very high purity level. Furthermore, crystalline inorganic particles, such as those produced by laser pyrolysis, can have a high degree of crystallinity. The degree of crystallinity can be evaluated by comparing integrated peak intensities for an x-ray diffractogram with comparable values for a standard diffractogram for the conventional bulk crystalline material.

Light reactive deposition is a versatile approach for the high rate formation of high quality coatings. The coating properties can be considered as deposited and/or after post-deposition processing. If multiple layers are deposited using light reactive deposition, there may or may not be additional processing before the deposition of a subsequent layer. The porosity of a layer can depend in part on the density of a particular layer. If the coating is deposited with a relatively large density relative to the fully densified material, the coating generally has reasonable mechanical stability. The coatings can be formed with smooth surfaces and a high degree of uniformity both across a particular coating as well as between coatings on different substrates that were deposited under equivalent conditions. These properties provide for the formation of useful large surface area structures.

The relative density of a coating is evaluated relative to the fully densified material of the same composition. For coatings deposited with lower densities, the coating can have a relative density of no more than about 0.65, in further embodiments from about 0.10 to about 0.6, and in other embodiments from about 0.2 to about 0.5. In general, the a dense coating can have a relative density in the range(s) of at least about 0.65, in other embodiments in the range(s) from about 0.7 to about 0.99, in some embodiments from about 0.75 to about 0.98 and in further embodiments in the range(s) from about 0.80 to about 0.95. A person of ordinary skill in the art will recognize that additional ranges within these specific ranges of coating density are contemplated and are within the present disclosure. For some materials, light reactive deposition can form a dense coating with approximately the same density as the fully densified material. The formation of dense coatings by light reactive deposition is described further in U.S. published patent application 2006/0134347A to Chiruvolu et al., entitled “Light Reactive Dense Deposition,” incorporated herein by reference.

Regardless of the density of the initial as-deposited coating, during post processing the density can be increased as desired to a selected value from the initial density to the full density. The density of the dense coating can be evaluated by weighting the substrate before and after coating and dividing the weight by the volume of the coating. Coating thickness can be evaluated using scanning electron microscopy. A decrease in density may or may not be associated with a measurable porosity of the surface. Porosity can also be evaluated using scanning electron microscopy (SEM).

To obtain particular objectives, the features of a coating can be varied with respect to composition of layers of the coating as well as location of materials on the substrate. Generally, to form a device the coating material can be localized to a particular location on the substrate. In addition, multiple layers of coating material can be deposited in a controlled fashion to form layers with different compositions. Similarly, the coating can be made a uniform thickness, or different portions of the substrate can be coated with different thicknesses of coating material.

Light reactive deposition can be used to form thick coatings. However, the approach has advantages for forming high quality coatings for applications in which an appropriate coating thickness is generally moderate or small, and very thin coatings can be formed as appropriate. Thickness is measured perpendicular to the projection plane in which the structure has a maximum surface area. For some applications, the coatings have a thickness in the range(s) of no more than about 2000 microns, in other embodiments, in the range(s) of no more than about 500 microns, in additional embodiments in the range(s) from about 5 nanometers to about 100 microns and in further embodiments in the range(s) from about 100 nanometers to about 50 microns. A person of ordinary skill in the art will recognize that additional range(s) within these explicit ranges and subranges are contemplated and are encompassed within the present disclosure.

The approaches described herein provide for the formation of coating layers that have very high uniformity within a layer and between layers formed under equivalent conditions. Thicknesses of a coating layer can be measured, for example, with an SEM analysis can be performed on a cross section, for example, at about 10 points along a first direction and about 10 points across the perpendicular direction. The average and standard deviation can be obtained from these measurements. In evaluating thickness and thickness uniformity of a coating layer, a one centimeter band along the edge can be excluded.

In some embodiments, one standard deviation of the thickness on a substrate with an area of at least about 25 square centimeters can be in the range(s) of less than about 10 microns, in other embodiments less than about 5 microns and in further embodiments from about 0.5 to about 2.5 microns. In addition, the standard deviation of the average thickness between a plurality of substrates coated under equivalent conditions can be less than about 10 microns, in other embodiments less than about 5 microns and in further embodiments from about 0.1 to about 2 microns. A person of ordinary skill in the art will recognize that additional deviations in thickness within a layer and between layers of different substrates within the explicit ranges above are contemplated and are within the present disclosure.

In some embodiments, very low surface roughness for a dense coating, with or without consolidation, on a substrate can be achieved. Surface roughness is evaluated generally with respect to a specific area of the surface for comparison. Different techniques may be particularly suited for the evaluation of surface roughness over particular areas due to time and resolution issues. For example, atomic force microscopy (AFM) can be used to evaluate a root mean square surface roughness over an approximate 20 micron by 20 micron area of a substrate, which is referred to herein as R_{AFM}. A suitable AFM instrument includes, for example, a Digital Instruments (Santa Barbara, Calif.) Model Nanoscope® 4. Using the techniques described herein, R_{AFM} values and similarly average roughness values (Rₐ) can be obtained in the ranges of no more than about 0.5 nanometers (nm), and in other embodiments in the ranges from about 0.1 nm to about 0.3 nm. Interferometry can be used to obtain surface roughness measurements over larger areas, such as 480 microns×736 microns. An interferometric profiler is an optical non-contact technique that can measure surface roughness from sub-nanometer to millimeter scales. A suitable interferometric profiler using digital signal processing to obtain surface profile measurement is a Wyko series profiler from Veeco Instruments Inc. (Woodbury, N.Y.). Using light reactive dense deposition, root mean square surface roughness (Rᵣₘₛ) values and similarly the average surface roughness (Rₐ) over 480 microns×736 microns can be obtained in the ranges of no more than about 10 nm and in further embodiments from about 1 nm to about 5 nm. A person of ordinary skill in the art will recognize that additional ranges of surface roughness within the explicit ranges are contemplated and are within the present disclosure.

Due to the very high deposition rate combined with the high coating uniformity with light reactive deposition, large substrates can be effectively coated. With larger widths of the substrate, the substrate can be coated with one or multiple passes of the substrate through the product stream. Specifically, a single pass can be used to coat an entire substrate surface if the substrate is roughly no wider than the inlet nozzle of the reactor such that the product stream is approximately as wide or wider than the substrate. In general, for convenience with respect to terminology, the length is distinguished from the width of a substrate in that during the coating process, the substrate is generally moved relative to its length and not relative to its width. As a result of being able to coat substrates with large widths and lengths, the coated substrates can have very large surface areas.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A apparatus comprising a reaction chamber and a reactant delivery system, wherein the reaction chamber comprises a optical elements defining a light beam path through the reaction chamber and wherein the reactant delivery system comprises an aerosol generator configured to deliver an aerosol into the reaction chamber, wherein the aerosol droplets in the reaction chamber have an average droplet diameter of no more than about 50 microns and less than 1 droplet in 10,000 having a diameter greater than 5 times the average droplet size.

2. The apparatus of claim 1 wherein the aerosol generator comprises a vessel having an outlet that is configured as an inlet into the reaction chamber, a gas permeable structure having a first surface exposed to the interior of the vessel and a second surface opposite to the first surface, a liquid delivery unit configured to deliver a liquid to the first surface of the gas permeable structure and a gas delivery unit configured to deliver a pressurized gas to the a second surface of the gas permeable structure to generate an aerosol that is delivered through the outlet.

3. The apparatus of claim 2 wherein the first surface is the exterior of a cylindrical structure.

4. The apparatus of claim 1 wherein the reactant delivery system is further configured to deliver a vapor precursor.

5. The apparatus of claim 1 wherein shielding gas outlets are positioned to direct gas and/or vapor adjacent aerosol from the aerosol generator within the reaction chamber.

6. The apparatus of claim 1 further comprising an infrared laser configured to deliver laser light along the light beam path.

7. The apparatus of claim 1 further comprising a particle collection system configured to receive the flow from the reaction chamber and to harvest at least a portion of product particles from the flow.

8. The apparatus of claim 1 further comprising a substrate holder and a translation system configured to translate the substrate holder relative to the flow.

9. The apparatus of claim 1 wherein the aerosol droplets in the reaction chamber have an average droplet diameter of no more than about 20 microns.

10. A apparatus comprising a reaction chamber and a reactant delivery system, wherein the reaction chamber comprises optical elements defining a light beam path through the reaction chamber and wherein the reactant delivery system comprises an aerosol delivery apparatus configured to deliver an aerosol into the light beam path with the edge of the aerosol generator positioned no more than about 6 centimeters of the closest edge of the light beam path with an average aerosol velocity of no more than about 5 meters per second and the average aerosol droplet size is not more than about 50 microns.

11. The apparatus of claim 10 wherein the aerosol generator comprises a vessel having an outlet that is configured as an inlet into the reaction chamber, a gas permeable structure having a first surface exposed to the interior of the vessel and a second surface opposite to the first surface, a liquid delivery unit configured to deliver a liquid to the first surface of the gas permeable structure and a gas delivery unit configured to deliver a pressurized gas to the a second surface of the gas permeable structure to generate an aerosol that is delivered through the outlet.

12. The apparatus of claim 10 wherein the reaction chamber operates at a pressure from about 80 Torr to about 700 Torr.

13. The apparatus of claim 10 wherein the average aerosol droplet size is not more than about 20 microns.

14. The apparatus of claim 10 further comprising an infrared laser configured to deliver laser light along the light beam path.

15. An aerosol generation apparatus comprising a non-cylindrical vessel wherein the vessel has an inner volume with a non-circular opening, a gas permeable structure with a surface exposed to the inner volume of the vessel and an opposing surface contacting an enclosed volume operably connected to a gas source, and a liquid delivery unit configured to deliver a liquid from a liquid supply to the exposed surface of the gas permeable structure.

16. The aerosol generation apparatus of claim 15 wherein the gas permeable structure comprises a cylinder having an interior and an outer surface, and wherein the exposed surface is along the outer surface of the cylinder.

17. The aerosol generation apparatus of claim 16 wherein the cylinder rotates and wherein a portion of interior of the cylinder forms the inner volume.

18. The aerosol generation apparatus of claim 16 wherein the non-circular opening has an aspect ratio of length to width of at least about 2.

19. A method for generating particles comprising flowing an aerosol through a light beam wherein the aerosol exits the aerosol generator within about 6 centimeter of the closest edge of the light beam at a velocity of no more than about 5 meters per second to produce particles having an average particle diameter of no more than about 500 nm and a essentially no particles having a diameter greater than about 5 times the average particle diameter.

20. The method of claim 19 wherein the aerosol is formed form a liquid comprising a plurality of metal/metalloid elements.

21. The method of claim 19 wherein a production run extends for at least an hour.

22. The method of claim 19 wherein the aerosol has an average droplet size of no more than about 20 microns.

23. The method of claim 22 wherein less than 1 droplet in 10,000 having a diameter greater than 5 times the average droplet size.

24. The method of claim 19 wherein the particle production rate is at least about 25 grams per hour.

25. The method of claim 19 wherein the carrier gas has a velocity of no more than about 2 meters per second.
